(19) United States
(12) Patent Application Publication
(10) Pub. No.: US 2007/0171306 A1
(43) Pub. Date: Jul. 26, 2007

(54) Digital television system with rapid channel surfing

(75) Inventors: Dietwig Lowet, Eindhoven (NL); Bernard van Vlimmeren, Veldhoven (NL); Harald Van Woerkom, Eindhoven (NL); Huib Eggenhuisen, Waalre (NL); Marcus Verhoeven, Eindhoven (NL); Robert Jochemsen, Eindhoven (NL); Clara Otero Perez, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/586,936

(22) PCT Filed: Jan. 27, 2005
(86) PCT No.: PCT/IB05/50357

§ 371 Date: Jul. 24, 2006

Related U.S. Application Data
(60) Provisional application No. 60/540,139, filed on Jan. 29, 2004.

(51) Int. Cl. H04N 5/45; H04N 9/74; H04N 5/268

(52) U.S. Cl. 348/565; 348/588; 348/706

(57) ABSTRACT

A digital television system includes a first tuner and first decoder for tuning to and decoding a selected digital television signal. A second tuner and second decoder are included for tuning to and decoding a separate digital television signal containing mosaic views of the receivable television signals. Upon a channel change command, first tuner is tuned to the new channel. Simultaneously, the output from the second decoder corresponding to the new channel is applied to the display. As such, the new channel is available for immediate viewing without waiting during the typical decoder delay.

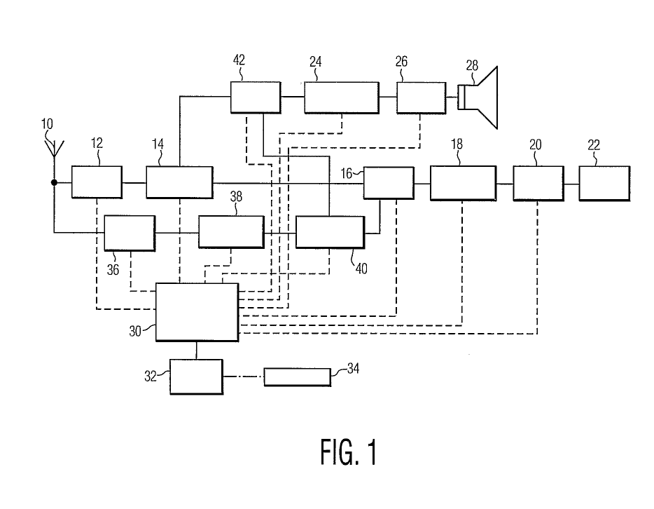

### FIELD OF THE INVENTION

The subject invention relates to digital television receivers, and more particularly, to channel “surfing” in digital television receivers.

### DESCRIPTION OF THE RELATED ART

Ever since the advent of wireless (or infrared (IR)) remote control units for television receivers, users have used these remote control units for scanning from channel to channel (“channel surfing”) in order to find out what is being telecast on the various receivable channels. With analog television signals, a channel change is effected merely by tuning the tuner to the new channel, and the change from channel to channel is substantially instantaneous allowing the user to channel surf very quickly. However, with digital television signals viewed on a digital television receiver, once the tuner is tuned to the new channel, various operations must be performed before the television signal is viewable on the display. This may include decoding the received television signal in an MPEG-2 decoder. All of this additional processing results in a delay of, for example, ½ second or more, before a viewable image is presented on the screen of the television receiver after a channel change. This delay is frustrating to the channel surfer and hampers quickly scanning viewable channels.

It is known to provide, in a digital television system, a separate channel containing mosaic views of all of the channels available in the digital television system. For example, International Patent Application No. WO 00/05886 discloses a navigation system for a multi-channel digital television system in which such a separate channel is tuned, decoded and a mosaic view is displayed on the television screen. A cursor, in the form of a highlight, is moved to a selected mosaic view and the tuner is then switched over to the appropriate television channel. However, even with this system, there is a decoder delay when switching from a particular desired channel to the mosaic views channel, and a decoder delay when switching from the mosaic views channel to the next desired channel.

It is an object of the present invention to provide a method and apparatus for receiving digital television signals that enables a user to quickly change from channel to channel without being bothered by typical decoder delays.

The above object is achieved in a digital television system comprising an input for receiving a plurality digital television signals; a first tuner coupled to said input for tuning to a selected one of said digital television signals capable of rendering a high quality video image; a first decoder coupled to said tuner for decoding said selected television signal; a video signal processor for processing said decoded television signal; and a display for displaying said decoded television signal, characterized in that said digital television system further comprises a second tuner coupled to said input for tuning to a separate television signal carrying mosaic views of all channels available in said digital television system, each of said mosaic view having a quality lower than that of digital television signals; a second decoder coupled to said second tuner for decoding said separate television signal carrying said mosaic views; a selector coupled to an output of said second decoder for selecting one of said decoded mosaic views; a video switch for alternatively coupling outputs from said first decoder and said selector to said video signal processor; and a controller coupled, to said first tuner, said selector and said video switch, said controller, in response to a channel change command, causing said first tuner and said selector to, in synchronism, switch to the same channel, and said video switch to temporarily switch to an output of said selector until said first decoder is able to provide a viewable image.

Applicant has noted that when a user is channel surfing, he/she is typically only concerned with the overall content on each channel. As such, temporarily watching a low quality version of the channel is sufficient for the user to determine whether the content of the channel is potentially interesting.

In the subject invention, in addition to the tuner and decoder which provides the signals for a television channel that a user is currently viewing, a separate tuner and decoder is used to tune to and decode the mosaic view signal in the background. When the user decides to change channels, the display is switched to a selector for selecting one of the decoded mosaic views. This selector, which is adjusted in synchronism with the main tuner, is then able to instantaneously provide a low quality image of the next channel for display, while the main tuner/decoder switches to and decodes the corresponding new channel. When a viewable image is available, the display switches back to the main tuner/decoder.

In a preferred embodiment of the subject invention, the digital television system further comprises an audio signal processing circuit for processing audio signals in a television signal, said audio signal processing circuit having a first input coupled to an output of said first decoder, and a second input coupled to an output of said selector; and at least one loudspeaker coupled to an output of said audio signal processing circuit for providing audio sounds corresponding to said audio signals, and said controller causes said audio signal processing circuit to switch to the output from said selector in synchronism with the switching of the video switch to the output from the selector.

In this embodiment, audio signals from the selector are switched to by an audio signal processor, when the controller switches the video switch to the selector. Thereby, the user also immediately hears the audio signal of the selected channel immediately upon switching to the channel.

In a further embodiment of the subject invention, the separate television signal containing the mosaic view is a high definition television signal. In this embodiment, the “low quality” of the mosaic view on display is mitigated.

With the above and additional objects and advantages in mind as will hereinafter appear, the invention will be described with reference to the accompanying drawing, in which:

The sole FIGURE shows a block circuit diagram of the television system of the subject invention.

As shown in the sole FIGURE, the digital television system of the subject invention, includes an input for receiving digital television signals, shown as antenna 10. While an antenna is show, it should be understood that a variety of other sources may include cable, satellite, etc. The input is connected to a first tuner 12 for tuning to one of the digital television signals. A first decoder 14 is shown coupled to an output of the first tuner 12 for decoding the tuned digital television signal. The first decoder 14 may be, for example, an MPEG decoder which is known in the art. The output of the decoder 14 is applied, via a video switch 16, to a video signal processor 18 for processing the video signals supplied by the video switch 16. This known processing may include contrast and brightness adjustments, as well as adjustments of the color content of the video signals. A display driver 20 receives the processed video signals and applies driving signals to a display 22.

The first decoder 14 further provides audio signals, included in the selected and decoded television signal, to an audio signal processor 24. After processing, the audio signals are amplified in audio amplifier 26 and provided to loudspeaker(s) 28.

A controller 30 is provided for controlling the first tuner 12, the first decoder 14, the video switch 16, the video signal processor 18, the display driver 20, the audio signal processor 24 and the audio amplifier 26. The controller receives user commands, via an infrared (IR) receiver 32, from an IR remote control unit 34 operated by the user.

The digital television system of the subject invention further comprises a second tuner 36 controlled to tune to a separate digital channel containing mosaic views of all the channels receivable by the digital television system. A second decoder 38 receives and decodes the digital television signals from an output from the second tuner 36. A selector 40 receives the decodes mosaic views from the second decoder 38 and selects one of the mosaic views. The selected mosaic view is applied to the video switch 16. The second tuner 36, the second decoder 38 and the selector 40 receive operating signals from the controller 30.

In operation, under control of control signals from the IR remote control unit 34, the controller 30 causes the first tuner 12 to tune to a selected digital television signal, the first decoder 14 to decode this selected digital television signal, the video switch 16 to supply the decoded television signal to the video signal processor 18 for display on the display 22. In addition, the controller 30 controls the audio signal processor 24 to process the corresponding audio signals from the first decoder 14 in order that appropriate sound signals are generated by the loudspeaker(s) 28. At the same time, the controller 30 causes the selector 40 to select the mosaic view corresponding to the digital television signal selected by the first tuner 12.

When the controller 30 receives a channel change command from the IR remote control unit 34, for example, when the user desires to channel surf, the controller 30 causes the first tuner 1 to tune to the next channel in accordance with the channel change command. Simultaneously, the controller 30 causes the selector 40 to select the corresponding mosaic view and the video switch 16 to switch to the output of the selector 40. If no further channel change commands are received by the controller 30, the controller 30 monitors the first decoder 14 and when a viewable image is available, causes the video switch 16 to switch back to the first decoder 14. In the event that a further channel change command is received, the controller 30 controls the first tuner 12 and selector 40 accordingly, while retaining the video switch 16 to receive signals from the selector 40.

In the embodiment as described above, Applicants note that when tuning to a new channel, while there is a delay in rendering the video signal, the audio signal is readily available (i.e., there are no I-frame packets for the audio, all audio packets being self-contained). Hence, there is no need to switch the audio signal. However, in the event that it is desired to switch the audio signal along with the video signal, as shown in the FIGURE, an audio output from the selector 40 as well as the audio output from the first decoder 14 are applied to an audio switch 42 controlled by the controller 30. An output from the switch then provides the input signal to the audio signal processor 24. As such, the controller 30 controls the audio switch 42 in synchronism with the video switch 16 such that when the video signal from the selector 40 is switched to the video signal processor 18, the audio signal from the selector 40 is switched to the audio signal processor 24.

Numerous alterations and modifications of the structure herein disclosed will present themselves to those skilled in the art. However, it is to be understood that the above described embodiment is for purposes of illustration only and not to be construed as a limitation of the invention. All such modification which do not depart from the spirit of the invention are intended to be included within the scope of the appended claims.

1. A digital television system comprising:
an input (10) for receiving a plurality of digital television signals;
a first tuner (12) coupled to said input (10) for tuning to a selected one of said digital television signals capable of rendering a high quality video image;
a first decoder (14) coupled to said first tuner (12) for decoding said selected television signal;
a video signal processor (18) for processing said decoded television signal; and
a display (22) for displaying said decoded television signal, characterized in that said digital television system further comprises:
a second tuner (36) coupled to said input (10) for tuning to a separate television signal carrying mosaic views of all channels available in said digital television system, each of said mosaic views having a quality lower than that of said digital television signals;
a second decoder (38) coupled to said second tuner (36) for decoding said separate television signal carrying said mosaic views;
a selector (40) coupled to an output of said second decoder (38) for selecting one of said decoded mosaic views;
a video switch (16) for alternatively coupling outputs from said first decoder (14) and said selector (40) to said video signal processor (18); and
a controller (30) coupled to said first tuner (12), said selector (40) and said video switch (16), said controller (30), in response to a channel change command, causing said first tuner (12) and said selector (40) to, in synchronism, switch to the same channel, and said video switch (16) to temporarily switch to an output of said selector (40) until said first decoder (14) is able to provide a viewable image.

2. The digital television system as claimed in claim 1, wherein the digital television system further comprises:
an audio signal processing circuit (24) for processing audio signals in a television signal;
an audio switch (42) having a first input coupled to an output of said first decoder (14), a second input coupled to an output of said selector (40), and an output coupled to an input of said audio signal processing circuit (24); and
at least one loudspeaker (28) coupled to an output of said audio signal processing circuit (24) for providing audio sounds corresponding to said audio signals,
and wherein said controller (30) causes said audio switch (42) to switch to the output from said selector (40) in synchronism with the switching of the video switch (16) to the output from the selector (40).

3. The digital television system as claimed in claim 1, wherein the separate television signal containing the mosaic view is a high definition television signal.
